(19) United States
(12) Patent Application Publication
(10) Pub. No.: US 2026/0261058 A1
(43) Pub. Date: Sep. 3, 2026

(54) GROUNDING APPARATUS AND METHOD

(71) Applicant: Ohmega Technologies LLC, Denver, CO (US)

(72) Inventor: Jacob L Downer, Middleton, ID (US)

(21) Appl. No.: 19/066,481

(22) Filed: Feb. 28, 2025

(51) Int. Cl. H01R 4/66; H02G 13/00

(52) U.S. Cl. CPC H01R 4/66; H02G 13/40

(57) ABSTRACT

A grounding apparatus connectable to a power source to be buried in the ground underneath a workspace adjacent to the power source to ground the workspace to prevent differences in electric potential between workers, the ground, and other equipment. The grounding apparatus has a frame including a head support and a tail support opposite the head support. A plurality of crossbars extend between the head support and the tail support. A conductor mounts on the frame and is arranged in a cyclically oscillating pattern from a first terminal of the conductor adjacent to a first end of the frame to a second terminal of the conductor opposite the first terminal adjacent to a second end of the frame opposite the first end. Retainers located at intervals along the conductor hold the conductor in position on the frame.

### BACKGROUND

The present disclosure is directed to a grounding apparatus and more particularly to an apparatus and method permitting connection to a power source and burying underneath a workspace adjacent the power source to prevent differences in electric potential between workers, the ground, and other equipment on or adjacent the workspace.

Electrical workers typically deenergize electrical lines and equipment before working on the lines and equipment to protect themselves from electric shock. In addition, workers use grounding equipment and practices as further protection in case the line or electrical equipment becomes inadvertently reenergized during work. To further protect workers, power companies use ground protection apparatus adjacent to power stations and electrical equipment to prevent differences in electric potential to protect workers. Such ground protection apparatus are designed to place the worker at an equipotential zone, or EPZ, protecting the worker from creating a path to ground and being subjected to an electrical shock. An EPZ mat is often used to create an EPZ by bonding the conductive components together and grounding them, such that a person standing on, or directly above, the EPZ mat has the same electrical potential as the EPZ mat. It is envisioned that the EPZ mat ensures the worker is at the same voltage as the equipment being serviced, thereby protecting the worker by ensuring there is no difference in voltage to induce a current in the body of the worker.

Such EPZ mats are often installed underground adjacent to power sources, creating a permanently grounded workspace, thereby ensuring the worker is protected by the EPZ mat. A typical installation requires digging a hole, manually arranging a conductor within the hole, connecting the conductor to the power source, and filling the hole over the conductor. These installations suffer from various drawbacks, including relying upon the installer to arrange the conductor in the correct shape or pattern, spending time in the field arranging the conductor, maintaining the conductor in position during backfill of the hole, and recalling the size and extent of the EPZ once the conductor is covered with earth or gravel.

In view of the drawbacks discussed above, there remains a need for a grounding apparatus that (i) maintains the exact arrangement of the conductor during installation without relying on installer expertise, (ii) speeds installation of the grounding apparatus by maintaining the conductor path during installation, (iii) holds the conductor in place during backfill of the hole, and (iii) has a specified, known size serving as a reminder to workers the extent of the grounded workspace.

### SUMMARY

In one aspect, the present disclosure includes a grounding apparatus connectable to a power source and sized and shaped to be buried in the ground underneath a workspace adjacent to the power source to ground the workspace to prevent differences in electric potential between workers, the ground, and other equipment. The grounding apparatus comprises a frame including a head support and a tail support opposite the head support. The grounding apparatus further comprises a plurality of crossbars, each crossbar of the plurality of crossbars extending between the head support and the tail support. The grounding apparatus further comprises a conductor mounted on the frame and arranged in a cyclically oscillating pattern from a first terminal of the conductor adjacent to a first end of the frame to a second terminal of the conductor opposite the first terminal adjacent to a second end of the frame opposite the first end. Each cycle of the cyclically oscillating pattern of the conductor comprises a first section extending along a first crossbar of the plurality of crossbars from the head support to the tail support, a second section adjoining the first section extending along the tail support from the first crossbar to a second crossbar, a third section adjoining the second section extending along the second crossbar from the tail support to the head support, and a fourth section adjoining the third section extending along the head support from the second crossbar to a third crossbar of the plurality of crossbars. The grounding apparatus further comprises a plurality of retainers located at intervals along the conductor to hold the conductor in position on the frame.

In another aspect, the present disclosure includes a grounding apparatus array connectable to a power source and sized and shaped to be buried in the ground underneath a workspace adjacent to the power source to ground the workspace to prevent differences in electric potential between workers, the ground, and other equipment. The grounding apparatus array comprises at least two grounding apparatuses sized and shaped for locating adjacent to each other to form the grounding apparatus array. Each of the grounding apparatuses comprises a frame including a head support and a tail support opposite the head support. Each of the grounding apparatuses comprises a plurality of crossbars, each crossbar of the plurality of crossbars extending between the head support and the tail support. Each of the grounding apparatuses comprises a conductor mounted on the frame and arranged in a cyclically oscillating pattern from a first terminal of the conductor adjacent to a first end of the frame to a second terminal of the conductor opposite the first terminal adjacent to a second end of the frame opposite the first end. Each cycle of the cyclically oscillating pattern of the conductor comprises a first section extending along a first crossbar of the plurality of crossbars from the head support to the tail support, a second section adjoining the first section extending along the tail support from the first crossbar to a second crossbar, a third section adjoining the second section extending along the second crossbar from the tail support to head support, and a fourth section adjoining the third section extending along the head support from the second crossbar to a third crossbar of the plurality of crossbars. Each of the grounding apparatuses comprises a plurality of retainers located at intervals along the conductor to hold the conductor in position on the frame. The at least two grounding apparatuses are connectable into the grounding apparatus array by connecting (i) one of the first terminal and the second terminal of the conductor of the first frame and (ii) one of a first terminal and a second terminal of the conductor of the second frame.

In yet another aspect, the present disclosure includes a method of installing a grounding apparatus permitting connection to a power source and burial in the ground underneath a workspace adjacent to the power source to ground the workspace to prevent differences in electric potential between workers, the ground, and other equipment. The method comprises selecting a location for the grounded workspace adjacent to the power source and determining a length and a width of the workspace. The method comprises selecting at least one grounding apparatus for placement underneath the workspace. The at least one grounding apparatus has a length and a width corresponding to the length and the width of the workspace. Each of the at least one grounding apparatuses comprises a frame, a conductor arranged along the frame from a first terminal of the conductor adjacent to a first end of the frame and extending along the frame and terminating in a second terminal of the conductor opposite the first terminal adjacent to a second end of the frame, and a plurality of retainers located at intervals along the conductor to hold the conductor in position on the frame. The method comprises digging a hole at the location of the workspace coextensive with the length and width of the workspace. The method comprises arranging the at least one grounding apparatus within the hole and connecting at least one of the first terminal and the second terminal to the power source. The method comprises filling the hole to cover the grounding apparatus.

Other aspects of the present disclosure will be apparent in view of the following description and claims.

### BRIEF DESCRIPTION OF DRAWINGS

The present disclosure includes non-limiting examples illustrated in the accompanying drawings.

FIG. 1 is a perspective of a first example of a grounding apparatus;

FIG. 2 is a top plan of a second example of a grounding apparatus; and

FIG. 3 is a flowchart of an example of a method of installing a grounding apparatus.

Corresponding reference characters indicate corresponding parts throughout the drawings.

### DETAILED DESCRIPTION

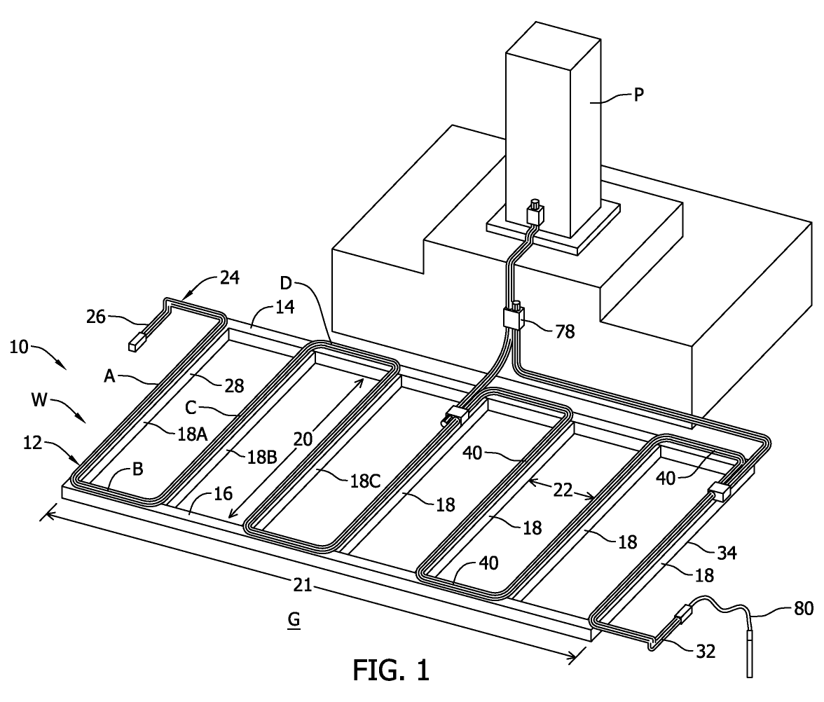

As shown in FIG. 1, one example of a grounding apparatus of the present disclosure is designated in its entirety by the reference number 10. The grounding apparatus 10 is connectable to a power source P and sized and shaped to be buried in the ground G below a workspace, generally indicated by W, adjacent to the power source to ground the workspace to prevent differences in electric potential between the workers, the ground, and other equipment on or adjacent the workspace caused by induced voltage, line reenergization, or lightning. Induced voltage is generated in a conductor when a magnetic field around the conductor changes. The grounding apparatus 10 includes a frame, generally indicated by 12, including a head support 14, a tail support 16 opposite the head support, and a plurality of crossbars 18. Each crossbar of the plurality of crossbars 18 extends between the head support 14 and the tail support 16. In one example, both the head support 14 and the tail support 16 are generally straight and elongated. Other head support 14 and tail support 16 shapes are contemplated. For instance, the head support could be serpentine, sawtooth-shaped, or bowed.

The elongated head support 14 and the elongated tail support 16 are generally parallel in the illustrated example. One skilled in the art would understand that the head support 14 and tail support 16 need not be parallel to provide a frame 12 suitable for use with this example. In the example shown in FIG. 1, the plurality of crossbars 18 are evenly spaced along the elongated head support 14 and the elongated tail support 16. It is envisioned that the crossbars 18 may have nonuniform spacing and the spacing may be different along the elongated head support 14 and the elongated tail support 16. Similarly, different numbers and spacings of crossbars are contemplated. In one example, the elongated head support 14 and the elongated tail support 16 are separated by a distance 20 of about three feet to about five feet. In some examples, the elongated head support 14 and the elongated tail support 16 are separated by a distance 20 of about four feet. In one example, the elongated head support 14 and the elongated tail support 16 have a length 21 of about five feet long to about seven feet long. In some examples, the elongated head support 14 and the elongated tail support 16 have a length 21 of about six feet long. Other distances 20 and lengths 21 are contemplated. In one example, adjacent crossbars 18 are separated by a distance 22 of about one foot.

The grounding apparatus 10 includes a conductor, generally indicated by 24, mounted on the frame 12 and arranged in a repeating or cyclically oscillating pattern from a first terminal 26 of the conductor adjacent to a first end 28 of the frame to a second terminal 32 of the conductor opposite the first terminal adjacent to a second end 34 of the frame opposite the first end. Each cycle of the cyclically oscillating pattern of the conductor 24 includes a sequence of four contiguous or adjoining sections in a sequence. A first section A extends along a first crossbar 18A from the head support 14 to the tail support 16. A second section B adjoining the first section A extends along the tail support 16 from the first crossbar 18A to a second crossbar 18B adjacent to the first crossbar. A third section C adjoining the second section B extends along the second crossbar 18B from the tail support 16 to the head support 14. A fourth section D adjoining the third section C extends along the head support 14 from the second crossbar 18B to a third crossbar 18C. Sections A, B, C, and D combine to form a single cycle of the cyclically oscillating pattern of the conductor 24.

Generally, the conductor 24 extends in the cyclically oscillating pattern along the crossbars 18, the head support 14, and the tail support 16 of the frame 12 to support the conductor and maintain the conductor in a proper configuration. As should be understood by one skilled in the art, some cycles of the cyclically oscillating pattern can be truncated. For example, the cyclically oscillating pattern of the last cycle of the frame 12 can include only a first section A if the frame includes only one final crossbar 18, such as if the frame has an odd number of crossbars as depicted in the first example of FIG. 1. Similarly, the cyclically oscillating pattern of the last cycle of the frame 12 can include only a first section A, a second section B, and a third section C if the frame includes only two additional crossbars 18, such as if the frame has an even number of crossbars. As would be understood by one skilled in the art, each crossbar 18 of the frame 12 need not include a conductor 24 extending along its length. Moreover, the cyclically oscillating pattern of the conductor 24 depicted in the example is one of repeating U-shapes having 90 degree turns, i.e., a square wave pattern. Other oscillating patterns, such as repeating V-shapes are also contemplated.

The conductor 24 is flexible, permitting the conductor to be routed along the crossbars 18, the head support 14, and the tail support 16 of the frame 12 in virtually any pattern or configuration. Rigid conductors 24 are also contemplated, such as a rigid conductor formed in the cyclically oscillating pattern described above. In one example, the conductor 24 comprises copper, although other electrically conducting materials, such as aluminum and silver, are also contemplated.

The grounding apparatus 10 includes a plurality of retainers 40 located at intervals along the conductor 24 to hold the conductor in position on the frame 12. Although many different types of retainers can be used, in one example, the plurality of retainers 40 comprise hose clamps, cable ties, or both.

The frame 12 comprises steel, aluminum, plastic, and/or fiberglass, although it is envisioned that other suitable frame materials could be used. Depending upon the material used, the head support 14, the tail support 16, and the plurality of crossbars 18 of the frame 12 can be joined to each other via welding, fasteners, or adhesives, as would be appreciated by one skilled in the art. The frame 12 can be coated, such as with paint, anodizing, or galvanizing, to protect the frame and enhance life and usability.

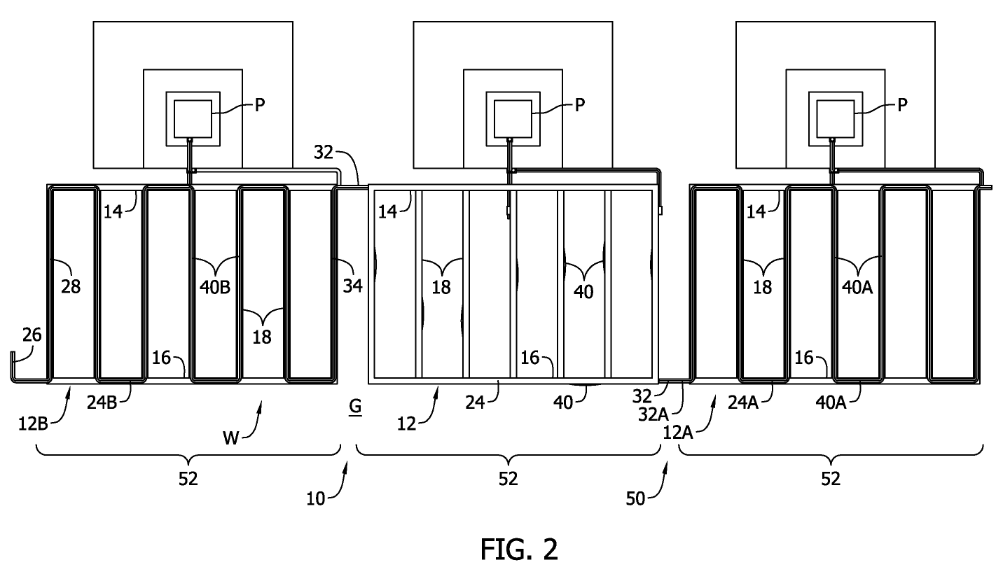

In a second example shown in FIG. 2, the grounding apparatus 10 includes a frame 12, conductor 24, and retainers 40 as described above. In addition, the grounding apparatus 10 additionally includes a second frame 12A, a second conductor 24A, and a second plurality of retainers 40A positioned adjacent to the frame 12. The addition of a second frame 12A roughly doubles the size of the workspace W. Moreover, the grounding apparatus 10 of the second example of FIG. 2 includes a third frame 12B and third conductor 24B, which will be discussed in more detail below with respect to a grounding apparatus array.

With respect to connecting conductors on adjacent frames, generally speaking, the conductors 24, 24A of the frame 12 and the second frame 12A are connectable by connecting (i) either the first terminal or the second terminal of the conductor on the first frame to (ii) either a first terminal or a second terminal of the conductor on the second frame. In the particular example depicted in FIG. 2, the second terminal 32 of the frame 12 and a second terminal 32A of the second frame 12A are connected. To facilitate this connection, the second frame 12A is oriented so the conductor 24A is beneath the frame 12A, thereby positioning the second terminal 32A of the second frame adjacent to the second terminal 32 of the frame 12 to permit convenient connection of the frames. The conductor 24 of the first frame 12 and the second conductor 24A of the second frame 12A are connectable using a conventional connector such as Cadweld exothermically-welded connectors or copper C-crimp connectors. Other connectors and connection methods are contemplated.

In another example, a grounding apparatus array, generally indicated by reference 50 in FIG. 2, is contemplated. Similarly to the previously described grounding apparatus, the grounding apparatus array is connected to a power source P and buried in the ground G underneath a workspace, generally indicated by W, adjacent to the power source to ground the workspace to prevent differences in electric potential between the workers, the ground, and other equipment. The grounding apparatus array 10 includes at least two grounding apparatus, generally designated by reference number 52, (FIG. 2 includes three grounding apparatus) configured to be located adjacent to each other to form the grounding apparatus array. Each of the grounding apparatus 52 includes a frame 12, 12A, 12B, a respective conductor 24, 24A, 24B, and a respective plurality of retainers 40, 40A, 40B, much as described in detail above. Each frame 12, 12A, 12B includes a head support 14, a tail support 16 opposite the head support, and a plurality of crossbars 18. Each crossbar 18 extends between the head support 14 and the tail support 16. The conductors 24, 24A, 24B mounted on the respective frames 12, 12A, 12B are arranged in a cyclically oscillating pattern from a first terminal 26 of the conductor adjacent to a first end 28 of the frame to a second terminal 32 of the conductor opposite the first terminal adjacent to a second end 34 of the frame opposite the first end, generally as described above with respect to other examples. In each cycle of the cyclically oscillating pattern, the conductors 24, 24A, 24B have four sections, as described above. The respective pluralities of retainers 40, 40A, 40B are spaced at intervals along respective conductors 24, 24A, 24B to hold the conductors in position on the respective frames 12, 12A, 12B. As shown in FIG. 2 and discussed above, the three grounding apparatus 52 are connectable into the grounding apparatus array 50 by connecting (i) either the first terminal or the second terminal of the conductor of a frame to (ii) either a first terminal or a second terminal of the conductor of an adjacent frame. As would be understood by those skilled in the art, multiple grounding apparatus are connectable into any sized array, such as a one by three apparatus array as depicted in the second example in FIG. 2, or in other combinations, such as a one by two apparatus array, a two by two apparatus array, a two by three apparatus array, etc.

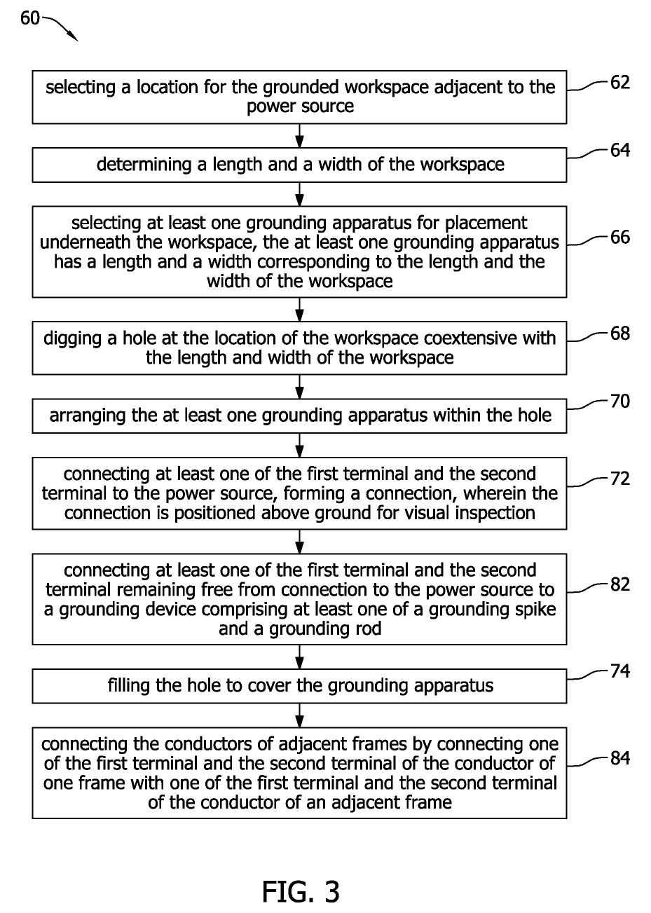

FIG. 3 illustrates one example of a method, designated in its entirety by reference number 60, of installing a grounding apparatus 10. The method 60 comprises selecting 62 a location for the grounded workspace W adjacent to the power source P and determining 64 a length and a width of the workspace. At least one grounding apparatus 10 is selected 66 for placement underneath the workspace W. In one example, the selected grounding apparatus 10 has a length and a width corresponding to the length and the width of the desired workspace W. The worker digs 68 a hole at the location of the workspace W coextensive with the length and width of the workspace and arranges 70 the grounding apparatus in the hole. The method 60 comprises connecting 72 either the first terminal 26 or the second terminal 32 to the power source P and filling 74 the hole to cover the grounding apparatus 10. Connecting 72 either the first terminal 26 or the second terminal 32 to the power source P forms a connection 78 (see FIG. 1), wherein the connection is positioned above ground G to permit visual inspection. The method 60 also includes connecting 82 either the first terminal 26 or the second terminal 32 remaining free from connection to the power source P to a grounding device 80 (see FIG. 1) comprising either a grounding spike or a grounding rod.

In another example, the selecting step 66 consists of selecting a plurality of grounding apparatus sized and shaped for locating adjacent to each other to span the desired workspace area. A first of the plurality of grounding apparatus 10 has a length and a width, and the remainder of the plurality of grounding apparatus having a similar length and width. The step of arranging 70 the grounding apparatus 10 comprises arranging the plurality of grounding apparatus adjacent to one another within the hole. The plurality of grounding apparatus 10 are arranged so they collectively have an overall length and an overall width corresponding to the length and the width of the workspace W. In this example, the method 60 comprises connecting 84 the conductors 24 of adjacent frames 12 by connecting either the first terminal 26 or the second terminal 32 of the conductor of one frame to either the first terminal or the second terminal of the conductor of an adjacent frame.

When introducing elements in this description and the claims, the articles "a", "an", "the", and "said" are intended to indicate one or more of the elements. The terms "comprising", "including", and "having" are intended to be inclusive, indicate there may be other elements in addition to those listed elements.

As those skilled in the art could make various changes to the above constructions, products, and methods without departing from the intended scope of the description, all matter in the above description and accompanying drawings should be interpreted as illustrative and not in a limiting sense. The patentable scope of the disclosure is defined by claims when present, and can include other constructions and methods as would occur to those skilled in the art. Such other constructions are intended to be within the scope of the claims if the structural elements of the constructions do not differ from the literal language of the claims, or if the constructions include equivalent structural elements having insubstantial differences from the literal languages of the claims.

To the extent that the specification, including the claims and accompanying drawings, discloses additional subject matter that is not within the scope of the claims, the disclosures are not dedicated to the public and the right to file one or more applications having claims directed the additional disclosures is reserved.

1. A grounding apparatus connectable to a power source and sized and shaped to be buried in the ground underneath a workspace adjacent to the power source to ground the workspace to prevent differences in electric potential between workers, the ground, and other equipment, said grounding apparatus comprising:
a frame including a head support and a tail support opposite the head support, a plurality of crossbars, each crossbar of said plurality of crossbars extending between the head support and the tail support;
a conductor mounted on the frame and arranged in a cyclically oscillating pattern from a first terminal of the conductor adjacent to a first end of the frame to a second terminal of the conductor opposite the first terminal adjacent to a second end of the frame opposite the first end, wherein in each cycle of the cyclically oscillating pattern of the conductor comprises a first section extending along a first crossbar of said plurality of crossbars from the head support to the tail support, a second section adjoining said first section extending along the tail support from the first crossbar to a second crossbar, a third section adjoining said second section extending along said second crossbar from the tail support to the head support, and a fourth section adjoining said third section extending along the head support from the second crossbar to a third crossbar of said plurality of crossbars; and
a plurality of retainers located at intervals along the conductor to hold the conductor in position on the frame.

2. A grounding apparatus as set forth in claim 1 wherein the head support is an elongated head support and the tail support is an elongated tail support.

3. A grounding apparatus as set forth in claim 2 wherein the elongated head support and the elongated tail support are generally parallel.

4. A grounding apparatus as set forth in claim 3 wherein the elongated head support and the elongated tail support are separated by a distance of about three feet to about five feet.

5. A grounding apparatus as set forth in claim 4 wherein the elongated head support and the elongated tail support are separated by a distance of about four feet.

6. A grounding apparatus as set forth in claim 2 wherein each of said elongated head support and said elongated tail support has a length of about five feet long to about seven feet long.

7. A grounding apparatus as set forth in claim 6 wherein each of said elongated head support and said elongated tail support has a length of about six feet long.

8. A grounding apparatus as set forth in claim 1 wherein the plurality of crossbars are evenly spaced.

9. A grounding apparatus as set forth in claim 8 wherein adjacent crossbars of said plurality of crossbars are separated by a distance of about one foot.

10. A grounding apparatus as set forth in claim 1 wherein said plurality of retainers comprise at least one of hose clamps and cable ties.

11. A grounding apparatus as set forth in claim 1 wherein the conductor comprises copper.

12. A grounding apparatus as set forth in claim 1 wherein said frame comprises at least one of steel, aluminum, plastic, and fiberglass.

13. A grounding apparatus as set forth in claim 1 further comprising a second frame, a second conductor, and a second plurality of retainers, wherein the conductor of the first frame and the second conductor are connectable between (i) one of the first terminal and the second terminal of the conductor of the first frame and (ii) one of a first terminal and a second terminal of the conductor of the second frame.

14. A grounding apparatus as set forth in claim 13 wherein the conductor of the first frame and the second conductor are connectable with a connection method comprising at least one of Cadweld exothermically-welded connectors and copper C-crimp connectors.

15. A grounding apparatus as set forth in claim 1 wherein the conductor is flexible.

16. A grounding apparatus array connectable to a power source and sized and shaped to be buried in the ground underneath a workspace adjacent to the power source to ground the workspace to prevent differences in electric potential between workers, the ground, and other equipment, said grounding apparatus array comprising:
at least two grounding apparatuses sized and shaped for locating adjacent to each other to form the grounding apparatus array, each of said grounding apparatuses comprises:
a frame including a head support and a tail support opposite the head support, a plurality of crossbars, each crossbar of said plurality of crossbars extending between the head support and the tail support;
a conductor mounted on the frame and arranged in a cyclically oscillating pattern from a first terminal of the conductor adjacent to a first end of the frame to a second terminal of the conductor opposite the first terminal adjacent to a second end of the frame opposite the first end, wherein in each cycle of the cyclically oscillating pattern of the conductor comprises a first section extending along a first crossbar of said plurality of crossbars from the head support to the tail support, a second section adjoining said first section extending along the tail support from the first crossbar to a second crossbar, a third section adjoining said second section extending along said second crossbar from the tail support to head support, and a fourth section adjoining said third section extending along the head support from the second crossbar to a third crossbar of said plurality of crossbars; and
a plurality of retainers located at intervals along the conductor to hold the conductor in position on the frame;
wherein said at least two grounding apparatuses are connectable into the grounding apparatus array by connecting (i) one of the first terminal and the second terminal of the conductor of the first frame and (ii) one of a first terminal and a second terminal of the conductor of the second frame.

17. A method of installing a grounding apparatus permitting connection to a power source and burial in the ground underneath a workspace adjacent to the power source to ground the workspace to prevent differences in electric potential between workers, the ground, and other equipment, said method comprising:
selecting a location for the grounded workspace adjacent to the power source;
determining a length and a width of the workspace;
selecting at least one grounding apparatus for placement underneath the workspace, said at least one grounding apparatus having a length and a width corresponding to the length and the width of the workspace, each of the at least one grounding apparatuses comprises:
a frame,
a conductor arranged along the frame from a first terminal of the conductor adjacent to a first end of the frame and extending along the frame and terminating in a second terminal of the conductor opposite the first terminal adjacent to a second end of the frame, and
a plurality of retainers located at intervals along the conductor to hold the conductor in position on the frame;
digging a hole at the location of the workspace coextensive with the length and width of the workspace;
arranging the at least one grounding apparatus within the hole;
connecting at least one of the first terminal and the second terminal to the power source; and
filling the hole to cover the grounding apparatus.

18. A method as set forth in claim 17 wherein said selecting at least one grounding apparatus for placement underneath the workspace further comprises selecting a plurality of grounding apparatuses sized and shaped for locating adjacent to each other, a first of the plurality of grounding apparatuses having a length and a width, the remainder of the plurality of grounding apparatuses having a similar length and width, said arranging the at least one grounding apparatus further comprises arranging the plurality of grounding apparatuses adjacent one another within the hole, said arrangement of said plurality of grounding apparatuses having an overall length and an overall width corresponding to the length and the width of the workspace; said method further comprising;
connecting the conductors of adjacent frames by connecting one of the first terminal and the second terminal of the conductor of one frame with one of the first terminal and the second terminal of the conductor of an adjacent frame.

19. A method of installing a grounding apparatus array as set forth in claim 17 further comprising connecting at least one of the first terminal and the second terminal remaining free from connection to the power source to a grounding device comprising at least one of a grounding spike and a grounding rod.

20. A method of installing a grounding apparatus array as set forth in claim 17 wherein said connecting at least one of the first terminal and the second terminal to the power source forms a connection, wherein the connection is positioned above ground to permit visual inspection.
